(19) United States
(12) Patent Application Publication
(10) Pub. No.: US 2006/0212642 A1
(43) Pub. Date: Sep. 21, 2006

(54) Partition allocation method and computer system

(75) Inventors: Jin Takahashi, Kawasaki (JP); Hiroshi Nakayama, Kawasaki (JP); Satoru Kagohashi, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/251,759

(22) Filed: Oct. 18, 2005

(30) Foreign Application Priority Data
Mar. 18, 2005 (JP) 2005-080667

(51) Int. Cl. G06F 13/00

(52) U.S. Cl. 710/317

(57) ABSTRACT

In a computer system in which a plurality of processor boards and a plurality of input and output (I/O) boards are coupled via an address and data crossbar, a partition allocation method allocates partitions in units of the processor boards and in units of I/O controllers within the I/O boards by software setting information indicating the partitions to which the plurality of I/O ports within each of the I/O boards belong, in a register part within a corresponding one of the I/O boards.

### CROSS-REFERENCE TO RELATED APPLICATIONS

This application claims the benefit of Japanese Application No. 2005-080667, filed Mar. 18, 2005, in the Japan Patent Office, the disclosure of which is incorporated herein by reference.

### BACKGROUND OF THE INVENTION

1. Field of the Invention

The present invention generally relates to partition allocation method and computer systems, and more particularly to a partition allocation method for allocating a plurality of partitions with respect to input and output (I/O) controllers and input and output (I/O) ports of a computer system, and to a computer system that employs such a partition allocation method.

2. Description of the Related Art

FIG. 1 is a block diagram showing an important part of a general computer system. As indicated in the top portion of FIG. 1, a computer system 1 includes a plurality of processor boards (processor systems) 2-0 through 2-M, an address and data crossbar 3, and a plurality of I/O boards (LSIs) 4-0 through 4-N, where M and N are arbitrary integers greater than or equal to 2. Each of the processor boards 2-0 through 2-M includes a plurality of CPUs, memories and the like. For example, the processor boards 2-0 through 2-P and the I/O board 4-0 form a partition P0, and the processor board 2-P+1 through 2-M and the I/O boards 4-1 through 4-N form a partition P1. The address and data crossbar 3 may be formed by an address crossbar and a data crossbar which are separate.

The lower portion of FIG. 1 shows a portion 10 including the address and data crossbar 3 and the I/O boards 4-0 through 4-N in more detail. Each of the I/O boards 4-0 through 4-N includes a plurality of I/O controllers, for example, I/O controllers 41A and 41B, an I/O port part 42, and a register part 43. The register part 43 includes a device number register that stores device numbers of the I/O controllers 41A and 41B within the I/O board to which this register part 43 belongs, and an address range register that stores an address range of the I/O port part 42 within the I/O board to which this register part 43 belongs. For example, the device numbers of the I/O controllers 41A and 41B within the I/O board 4-0 respectively are #0 and #1, the device numbers of the I/O controllers 41A and 41B within the I/O board 4-1 respectively are #2 and #3, and the device numbers of the I/O controllers 41A and 41B within the I/O board 4-N respectively are #2N and #2N+1.

FIG. 2 is a diagram showing the I/O port part of the I/O board. Since the structures of each of the I/O boards 4-0 through 4-N are the same, FIG. 2 shows the structure of the I/O board 4-0 as an example. The I/O port part 42 of the I/O board 4-0 has 8 I/O ports 42-0 through 42-7, for example. Conventionally, whether the I/O ports 42-0 through 42-7 belong to the I/O controller 41A or 41B is fixedly determined (for example, hard wired). In the example shown in FIG. 2, the I/O ports 42-0 through 42-3 belong to the I/O controller 41A, and the I/O ports 42-4 through 42-7 belong to the I/O controller 41B. Each of the I/O ports 42-0 through 42-7 are connectable to various kinds of resources, such as (without limitation) I/O devices, such as magnetic disk drives. Because a partition may be determined in units of a processor board 2-0 and in units of I/O controllers 41 within an I/O board 4-0, it is possible to include the I/O controller 41A in a partition P3 and to include the I/O controller 41B in a partition P4, for example. But since the I/O controllers 41A and 41B to which the I/O ports 42-0 through 42-7 belong are fixedly determined in advance, the I/O ports 42-0 through 42-3 are fixedly included in the partition P3 and the I/O ports 42-4 through 42-7 are fixedly included in the partition P4 in this particular case.

FIG. 3 is a diagram for explaining an access from the processor board towards the I/O device. In FIG. 3, a circuit indicated by a triangular symbol denotes a comparator that outputs “1” when 2 inputs thereof match and outputs “0” when 2 inputs thereof do not match. A circuit indicated by “AND” denotes an AND gate. In addition, portions of the I/O board 4-0 related to steps S1 through S4 are surrounded by one-dot chain lines.

For example, in FIG. 3; in case of an access from the processor board 2-0 towards an I/O device, a request packet is sent to the I/O board 4-0 from the processor board 2-0 (step S1). The request packet is made up of a partition identifier (ID) (PID), which comprises a device number of an I/O controller 41; an address (Address), such as a physical address of a request target, an address space (or address range) and an I/O address; and a request content (Request) including commands and data. In the I/O board 4-0, the PID of the request packet is compared with the device numbers #0 and #1 of the I/O controllers 41A and 41B within the I/O board 4-0 that are stored in a device number register 431 of the register part 43 within the I/O board 4-0 (step S2). At the same time, the address of the request packet is compared with the address ranges of each of the I/O ports 42-0 through 42-7 that are stored in an address range register 432 of the register part 43 (step S3). The request packet reaches only the I/O port 42 that belongs to the I/O controller 41A or 41B having the matching device number as a result of the comparison made in the step S2 and that also has the matching address as a result of the comparison made in the step S3 (step S4), and access is made to the desired I/O device via this I/O port 42.

FIG. 4 is a diagram for explaining an access from the I/O device towards the processor board 2-0. For example, in the case of access from the I/O board 4-0 towards the processor board 2-0, the I/O port 42 sends to the processor board 2-0 via the address and data crossbar 3 a request packet having a PID written with the device number of an I/O controller 41A or 41B to which this I/O port 42 belongs, based on the request received from the I/O device and including the address (Address) and the request content (Request). For example, if one of the I/O ports 42-0 through 42-3 of the I/O board 4-0 receives the request from the I/O device, the request packet having the PID written with the device number #0 of the I/O controller 41A of the I/O board 4-0 is sent to the processor board 2-0. In addition, if one of the I/O ports 42-4 through 42-7 of the 1/O board 4-0 receives the request from the I/O device, the request packet having the PID written with the device number #1 of the I/O controller 41B of the I/O board 4-0 is sent to the processor board 2-0.

Japanese Laid-Open Patent Publication No. 09-231187 discusses a method of dividing a crossbar switch into partitions. In addition, Japanese Laid-Open Patent Publication No. 2001-236305 discusses a bus connecting controller that can vary the corresponding relationship of the connection to an external bus depending on data exchanged via the external bus.

In the conventional computer system, the I/O controllers 41A and 41B to which the 1/O ports 42-0 through 42-7 belong are fixedly determined in advance for each of the I/O boards 4-0 through 4-N. For this reason, although a partition may be determined in units of I/O controllers 41A and 41B, each of the I/O ports 42-0 through 42-3 allocated with respect to the I/O controller 41A cannot be freely allocated to another partition to which the I/O controller 41B belongs, even if usable, because the I/O ports 42-0 through 42-7 of each of the I/O boards 4-0 through 4-N are fixedly allocated with respect to the I/O controllers 41A and 41B. Consequently, for example, there has been problems in that the degree of freedom of partition allocation is poor, and/or it has been difficult to improve the utilization efficiency of the resources.

### SUMMARY OF THE INVENTION

Accordingly, as unlimiting examples, the present invention provides partition allocation methods and computer systems that can improve a degree of freedom of partition allocation and/or a utilization efficiency of resources.

Additional aspects and advantages of the invention will be set forth in part in the description which follows and, in part, will be obvious from the description, or may be learned by practice of the invention.

A partition allocation method is provided for a computer system in which a plurality of processor boards and a plurality of input and output (I/O) boards are coupled via an address and data crossbar, to allocate partitions in units of the processor boards and in units of I/O controllers within the I/O boards, characterized by setting via software information indicating partitions to which the plurality of I/O ports within each of the I/O boards belong in a register part within a corresponding one of the I/O boards.

A computer system characterized by a plurality of processor boards each including a plurality of processors; a plurality of input and output (I/O) boards each including a plurality of I/O controllers and a plurality of I/O ports; and an address and data crossbar coupling the plurality of processor boards and the plurality of I/O boards, wherein each of the I/O boards includes a register part software settable with information indicating partitions of a processor board and an I/O controller within an I/O board to which the plurality of I/O ports within each I/O board belong.

According to an aspect of the present invention, an identifier (ID) of a partition assignment within the I/O board in which each of the I/O ports exists is set in the register part as said information indicating the partitions to which the plurality of I/O ports within each of the I/O boards belong.

According to an aspect of the present invention, information indicating the I/O controllers within the I/O board to which each of the I/O ports is assigned is set in the register part as said information indicating the partitions to which the plurality of I/O ports within each of the I/O boards belong.

According to an aspect of the present invention, the software is executed by an arbitrary one of a plurality of processors within an arbitrary one of the processor boards.

According to an aspect of the present invention, said register part includes a device number register to store a device number of each of the I/O controllers within said corresponding one of the I/O boards, an address range register to store an address range of each of the I/O ports within said corresponding one of the I/O boards, and an assignment information register to store said information indicating the assigned I/O controllers for each of the I/O ports within said corresponding one of the I/O boards.

According to an aspect of the present invention, said corresponding one of the I/O boards, upon receipt of a request packet instructing an access from an arbitrary one of the processor boards towards a desired I/O device that is coupled to said corresponding one of the I/O boards, compares a partition ID of the request packet with device numbers of the I/O controllers that are stored in the device number register, based on the I/O port to I/O controller assignment information that is set in the assignment information register, and at same time, compares an address of the request packet with address ranges of each of the I/O ports that are stored in the address range register, so that the request packet reaches only an I/O port that belongs to the I/O controller having the matching device number and the matching address as a result of the comparisons made, to make the access to the desired I/O device via this I/O port.

According to an aspect of the present invention, said corresponding one of the I/O boards, upon receipt via one I/O port of a request instructing an access from an I/O device that is coupled to said corresponding one of the I/O boards towards a desired processor board, sends to the desired processor board via the address and data crossbar a request packet having a partition ID written with the device number of the I/O controller to which said one I/O port belongs.

According to an aspect of the present invention, said corresponding one of the I/O boards, upon receipt of said request, generates the request packet having the partition ID written with the device number of the I/O controller to which said one I/O port belongs, based on the I/O port to I/O controller assignment information set in said assignment information register.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing an important part of a general computer system.

FIG. 2 is a diagram showing the I/O port part of the I/O board.

FIG. 3 is a diagram for explaining an access from the processor board towards the I/O device.

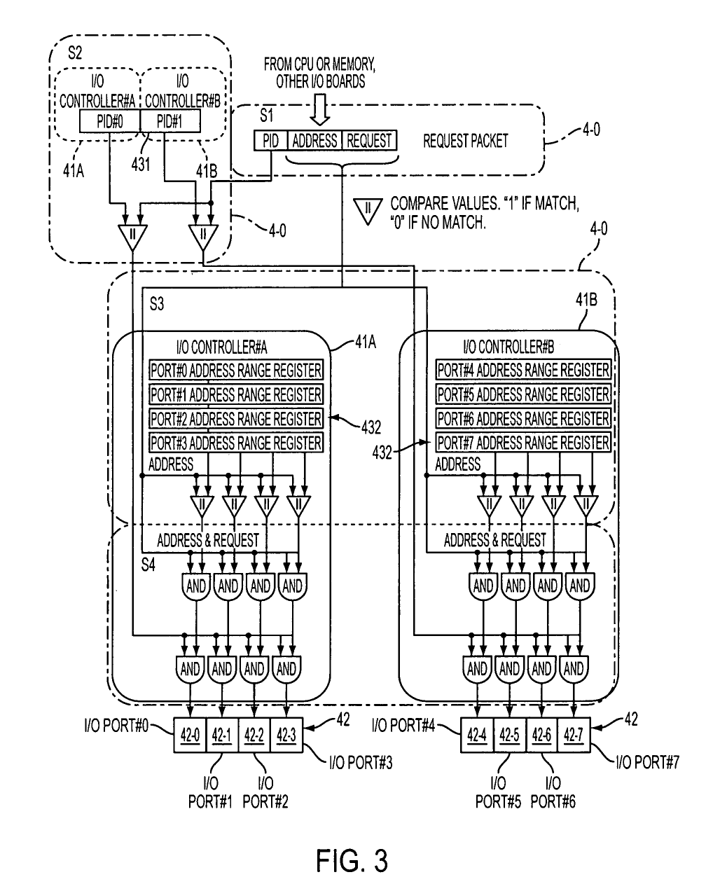

FIG. 4 is a diagram for explaining an access from the I/O device towards the processor board.

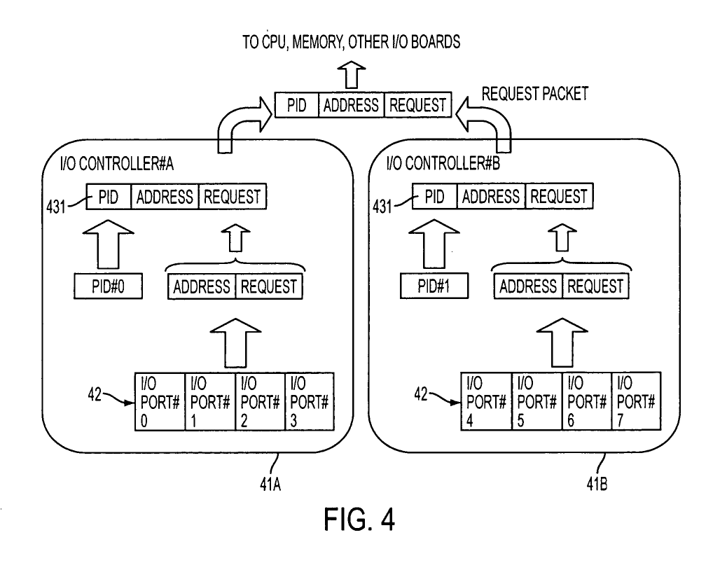

FIG. 5 is a diagram showing an I/O port part of an I/O board of an embodiment of a computer system, according to an embodiment of the present invention.

FIG. 6 is a diagram for explaining an access from the processor board towards the I/O device, according to an embodiment of the present invention.

FIG. 7 is a diagram for explaining an access from the I/O device towards the processor board, according to an embodiment of the present invention.

FIG. 8 is a diagram showing assignments of PCI function numbers F#0 through F#7 in one arbitrary PCI bus configuration space to the I/O ports of I/O controllers, according to an embodiment of the present invention.

FIG. 9 is a diagram showing assignments of the I/O ports belonging to the 2 I/O controllers within each of the I/O boards to PCI functions, according to an embodiment of the present invention, according to an embodiment of the present invention.

FIG. 10 is a diagram showing the assignments of the function numbers to the I/O ports of the I/O controllers for a case where specific I/O ports of the I/O board belong to one I/O controller and the other I/O ports of the same I/O board belong to the other I/O controller, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

According to the present invention, for example (without limitation), it is possible to realize partition allocation methods and computer systems that can improve a degree of freedom of partition allocation and/or utilization efficiency of resources. In a computer system in which a plurality of processor boards and a plurality of input and output (I/O) boards are coupled via an address and data crossbar, a partition allocation method allocates partitions in units of the processor boards and the I/O controllers within the I/O boards, by setting via software information indicating partitions to which the plurality of I/O ports within each of the I/O boards belong, in a register part within a corresponding one of the I/O boards. According to an aspect of the present invention, the partition allocation is real-time and/or dynamic.

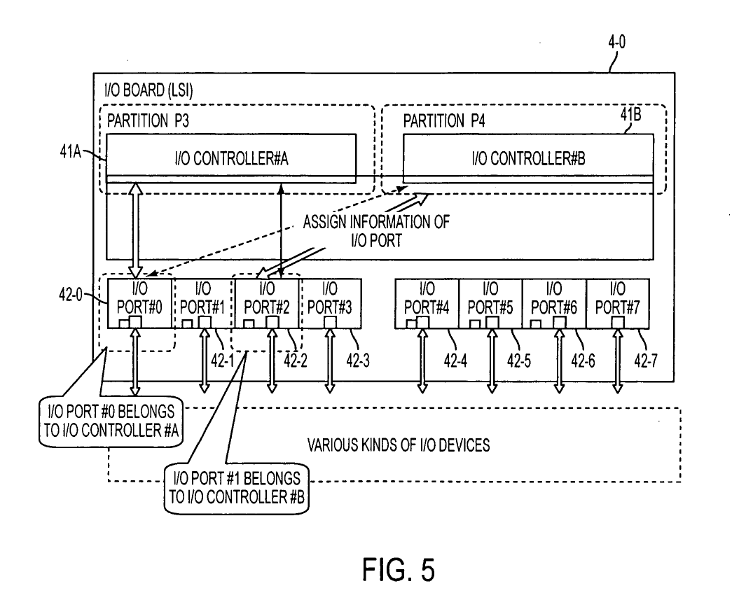

A description will be given of embodiments of the partition allocation method and the computer system according to the present invention, by referring to FIG. 5 and the subsequent drawings.

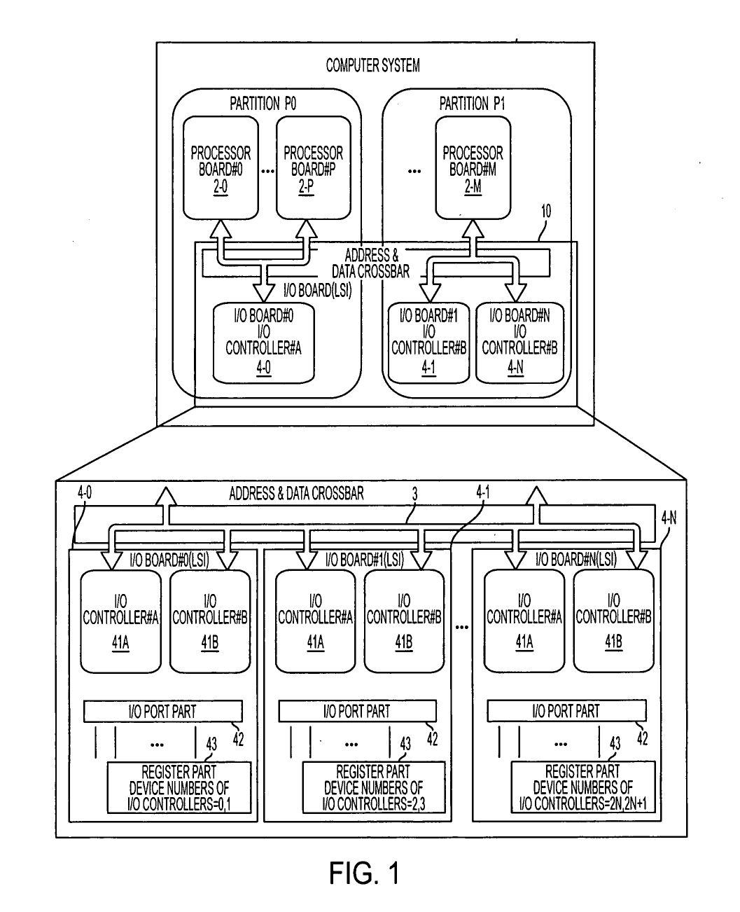

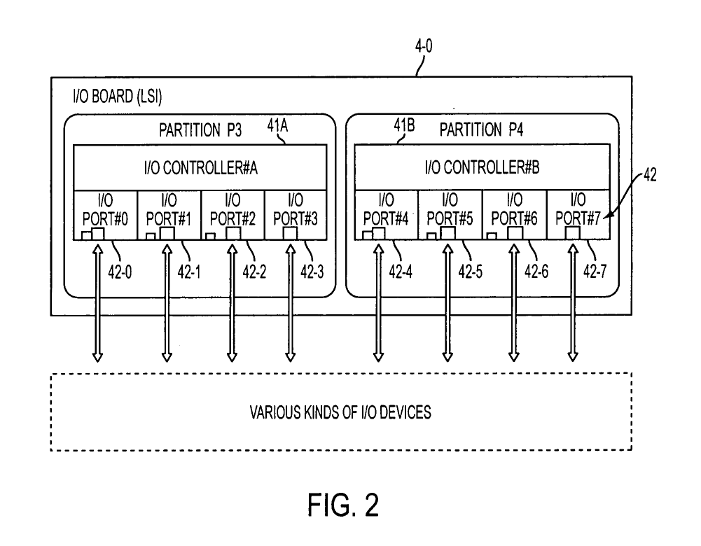

A computer system embodying the present invention could have a basic structure same as the basic structure of the example shown in FIG. 1, and a description and illustration thereof will be omitted. An embodiment of the present invention in the computer system 1 is characterized by the structure of the I/O board 4-0. FIG. 5 is a diagram showing an I/O port part of an I/O board, according to an embodiment of the present invention. In FIG. 5, those parts which are essentially the same as those corresponding parts in FIGS. 1 and 2 are designated by the same reference numerals. The computer system 1 embodying the present invention as shown in FIG. 5 employs a partition allocation method, according to an embodiment of the present invention.

The structures of each of the I/O boards 4-0 through 4-N are the same, and FIG. 5 shows the structure of the I/O board 4-0 as an example. The I/O port part 42 of the I/O board 4-0 has 8 I/O ports 42-0 through 42-7, for example. Conventionally, the I/O controllers 41A and 41B to which the I/O ports 42-0 through 42-7 belong are fixedly determined. But according to the present invention, assignment information of I/O ports (I/O port to I/O controller assignment information or I/O port partition assignment information) that indicates an I/O controller, for example, I/O controller 41A or 41B, to which each of the I/O ports 42-0 through 42-7 belongs, can be arbitrarily set by software, that is, arbitrarily set by the CPU within the processor board 2-0, for example. In the case shown in FIG. 5, the assignment information is set so that the I/O ports 42-0, 42-1, 42-5 and 42-7 belong to the I/O controller 41A and the I/O ports 42-2, 42-3, 42-4 and 42-6 belong to the I/O controller 41B. Each of the I/O ports 42-0 through 42-7 is connectable to various kinds of I/O devices, such as magnetic disk drives. Because a partition may be determined in units of processor boards 2-0 and in units of I/O controllers 41A or 41B within an I/O board 2-0, it is possible to include the I/O controller 41A in the partition P3 and to include the I/O controller 41B in the partition P4, for example.

According to an aspect of the present invention, if the assignment information of the I/O ports 42 cannot be changed directly from a processor board 2-0, a management processor board that manages configuration information, such as the assignment information, the partition ID (PID) and the configuration address, can be provided to set the assignment information of the I/O ports 42. In other words, it is possible to provide an exclusive processor board that makes a setting on whether a processor board 2-0 and an I/O controller 41 within an I/O board 4-0 are to form a partition, and to manage the configuration information described above and execute the software that sets the assignment information. Such an exclusive processor board may communicate indirectly with the other processor boards 2-0.

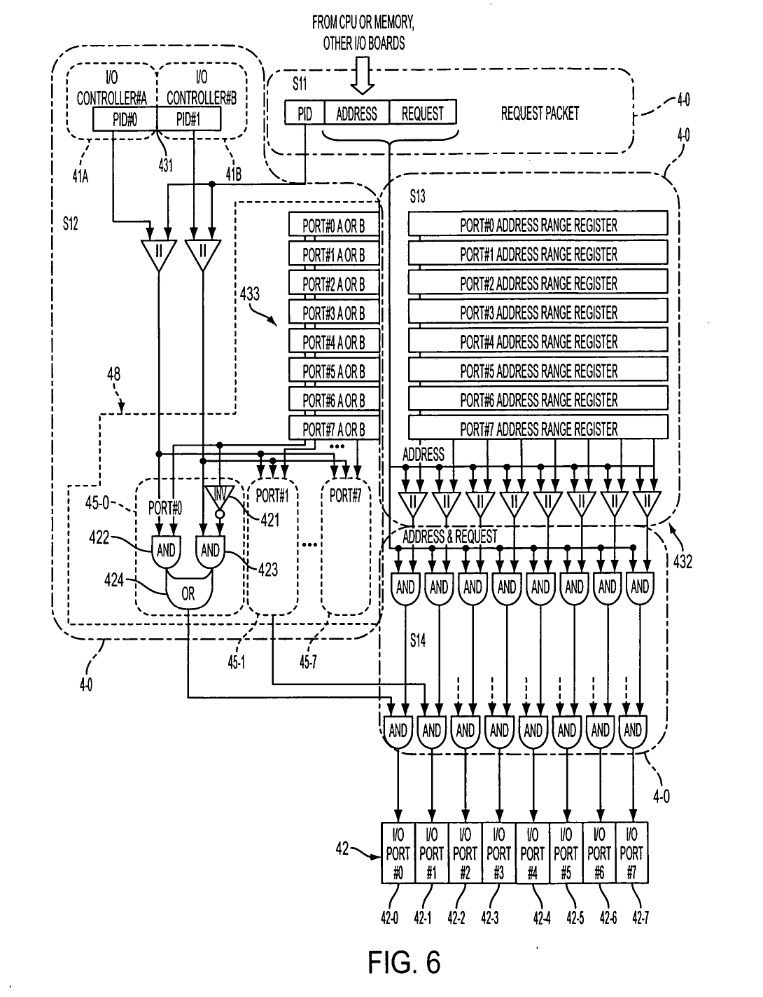

In the example computer system embodiment described herein, each of the I/O boards 4-0 through 4-N includes the I/O controllers 41A and 41B, the I/O port part 42 and the register part 43, as described above in conjunction with FIG. 1. The register part 43 comprises the device number register 431 that stores the device numbers of the I/O controllers, such as the I/O controllers 41A and 41B, within the I/O board 4-0 to which this register part 43 belongs, the address range register 432 that stores the address range of the I/O port part 42 within the I/O board 4-0 to which this register part 43 belongs, and an I/O port assignment information register 433 (see FIG. 6). The I/O port assignment information that indicates whether each of the I/O ports 42-0 through 42-7 belongs to an I/O controller, such as I/O controller 41A or 41B (i.e., to which partition, in units of an I/O controller within an I/O board, the I/O ports belong), is set in the I/O port assignment information register 433 by the software.

FIG. 6 is a diagram for explaining an access from the processor board towards the I/O device, according to an embodiment of the present invention. In FIG. 6, a circuit indicated by a triangular symbol denotes a comparator that outputs “1” when 2 inputs thereof match and outputs “0” when 2 inputs thereof do not match. A circuit indicated by “AND” denotes an AND gate, and a circuit indicated by “OR” denotes an OR gate. In addition, portions of the I/O board 4-0 related to steps S11 through S14 are surrounded by one-dot chain lines.

In FIG. 6, for example, in the case of the access from the processor board 2-0 towards the I/O device, a request packet is sent to the I/O board 4-0 (step S11). The request packet is made up of a partition ID (PID); an address (Address), such as a physical address of a request target, an address space (or address range) and an I/O address; and a request content (Request) including commands and data. In the I/O board 4-0, the PID of the request packet is compared with the device number #0 of the I/O controller 41A within the I/O board 4-0 that is stored in the device number register 431 of the register part 43 within the I/O board 4-0 for the I/O ports belonging to the I/O controller 41A, and compared with the device number #1 of the I/O controller 41B within the I/O board 4-0 that is stored in the device number register 431 of the register part 43 within the I/O board 4-0 for the I/O ports belonging to the I/O controller 41B, based on the I/O port assignment information that is set in the I/O port assignment information register 433 of the register part 43 within the I/O board 4-0 (step S12). According to an aspect of the present invention, the I/O port assignment information register 433 can implemented, for example, as part of the register part 43 and/or as a new separate register. Further, although the embodiments described herein refer to a register in which I/O port assignment information can be set, the present invention is not limited to such a configuration and the I/O port information can be set in any software settable or computer readable media within an I/O board. According to an aspect of the present invention, the I/O port assignment information register 433 can be seen by a processor board 2-0 to be set/configured via software executing at the processor board 2-0. According to an aspect of the present invention, typically in the present invention, a PID written with or comprising a device number of an I/O controller to which an I/O port belongs, is configured at a time of (for example, prior to) booting the computer system 1 and/or according to dynamic reconfiguration methods provided in/used by the computer system 1. The I/O port assignment information set in the I/O port assignment information register 433 is used to identify, based upon the PID, the I/O port 42 allocated to I/O controller 41 within the I/O board 4-0. Circuits 45-0 through 45-7 shown in FIG. 6 are provided in correspondence with the I/O ports 42-0 through 42-7 to execute the step S12 described above. The circuits 45-0 through 45-7 can have the same structure; and, for example, each circuit 45 can comprise an inverter 421, AND gates 422 and 423, and an OR gate 424 to identify to which I/O controller and I/O port belongs. In addition, at the same time as the step S12, the address of the request packet is compared with the address ranges of each of the I/O ports 42-0 through 42-7 that are stored in the address range register 432 of the register part 43 (step S13). As step S14, the request packet reaches only the I/O port 42 that belongs to the I/O controller 41 having a matching device number as a result of the comparison made in the step S12 and that also has the matching address as a result of the comparison made in the step S13 (step S14), and the access is made to the desired I/O device via identified I/O port. According to an aspect of the present invention, as an example, a first partition allocation unit 48 comprises the I/O port assignment information register 433 and the circuit(s) 45. The partition allocation unit 48 can be implemented in software, programmable computing hardware, computing hardware/devices or any combinations thereof.

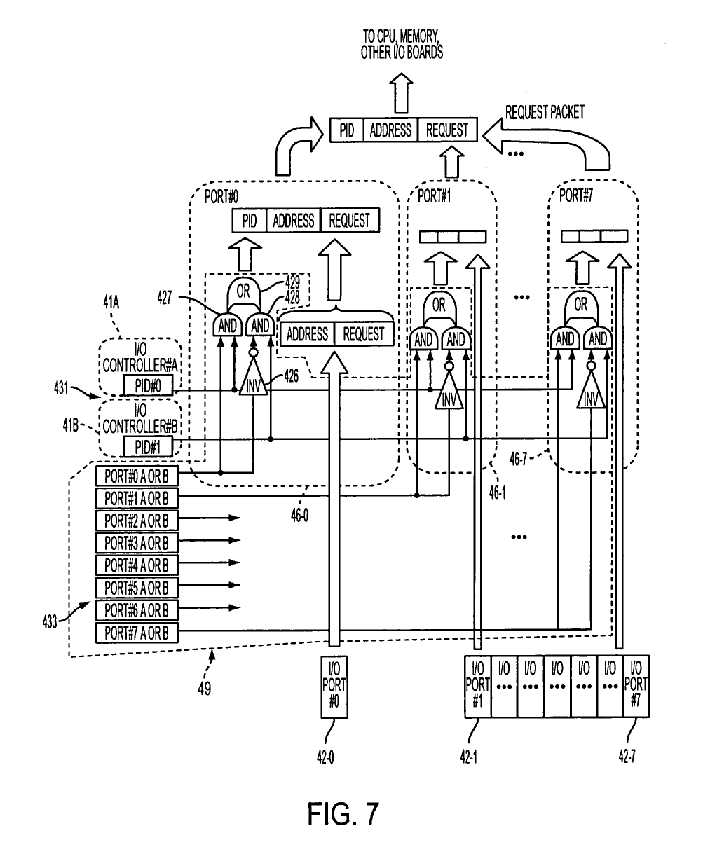

FIG. 7 is a diagram for explaining an access from the I/O device towards the processor board, according to an embodiment of the present invention. For example, in the case of an access from the I/O board 4-0 towards the processor board 2-0, the I/O port 42 sends to the processor board 2-0 via the address and data crossbar 3 a request packet having a PID written with the device number of the I/O controller 41 to which this I/O port 42 belongs, based on the request received from the I/O device and including the address (Address) and the request content (Request). For example, if one of the I/O ports 42-0, 42-1, 42-5 and 42-7 of the I/O board 4-0 receives the request from the I/O device, the request packet having a PID written with the device number #0 of the I/O controller 41A (the device number #0 stored in the device number register 431 of the register part 43 within the I/O board 4-0) and information as to which I/O controller 41A the I/O ports 42-0, 42-1, 42-5 and 42-7 belong, is sent, based on the I/O port assignment information that is set in the I/O port assignment information register 433 of the register part 43 within the I/O board 4-0. In addition, if one of the I/O ports 42-2, 42-3, 42-4 and 42-6 of the I/O board 4-0 receives the request from the I/O device, the request packet having a PID written with the device number #1 of the I/O controller 41B of the I/O board 4-0 (the device number #1 stored in the device number register 431 of the register part 43 within the I/O board 4-0) and information as to which I/O controller 41B the I/O ports 42-2, 42-3, 42-4 and 42-6 belong, is sent, based on the I/O port assignment information that is set in the I/O port assignment information register 433 of the register part 43 within the I/O board 4-0. Circuits 46-0 through 46-7 shown in FIG. 7 are provided in correspondence with the I/O ports 42-0 through 42-7 to send the request packet described above. The circuits 46-0 through 46-7 can have the same structure; and, for example, each circuit 46 can comprise an inverter 426, AND gates 427 and 428, and an OR gate 429 to identify to which I/O controller an I/O port belongs. According to an aspect of the present invention, as an example, a second partition allocation unit 49 comprises the I/O port assignment information register 433 and the circuit(s) 46. The partition allocation unit 49 can be implemented in software, programmable computing hardware, computing hardware/devices or any combinations thereof. Further, the first and second partition allocators 48 and 49 can be implemented as one or a plurality of components in software, programmable computing hardware, computing hardware/devices or any combinations thereof.

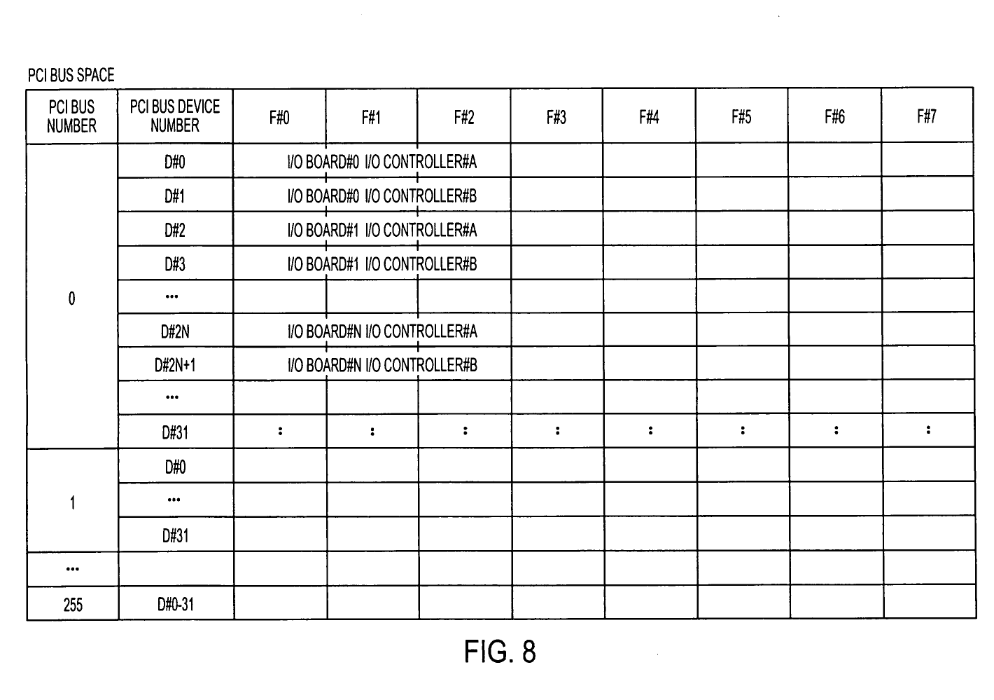

FIG. 8 is a diagram showing assignments of PCI function numbers F#0 through F#7 in one arbitrary PCI bus configuration space to I/O ports of I/O controllers, according to an embodiment of the present invention. In particular, FIGS. 8-10 are directed to an aspect of the present invention when an I/O board 4-0 comprising a plurality of I/O controllers 41 provides or is implemented as a Peripheral Component Interconnect (PCI) interface to various PCI devices. The present invention allows assigning PCI functions to any I/O ports of I/O controllers in an I/O board. As shown in FIG. 8, the PCI function numbers F#0 through F#7 of each of PCI bus device numbers D#0 through D#31 are assigned with respect to each of PCI bus numbers 0 through 255. For example, the I/O controller #A (41A) of the I/O board #0 (4-0) is assigned to the function numbers F#0 through F#7, with respect to the device number D#0 of the PCI bus number 0. In addition, the I/O controller #B (41B) of the I/O board #0 (4-0) is assigned to the function numbers F#0 through F#7, with respect to the device number D#1 of the PCI bus number 0. Furthermore, the I/O controller #A (41A) of the I/O board #1 (4-1) is assigned to the function numbers F#0 through F#7, with respect to the device number D#2 of the PCI bus number 0. Such assignments of the function numbers F#0 through F#7 are made with respect to each PCI bus configuration space, that is, each partition of processor board(s) 2-0 and I/O controller(s) 41 within I/O board(s) 4-0.

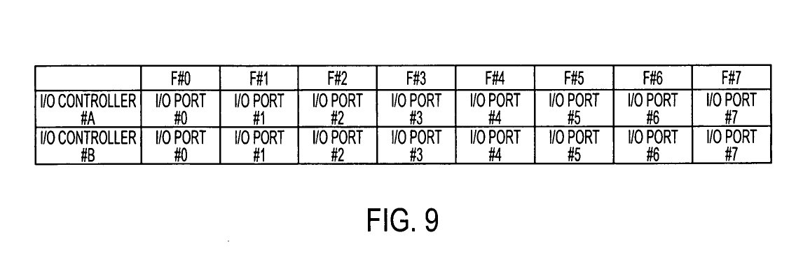

As an example, FIG. 9 is a diagram showing assignments of the I/O ports #0 through #7 (42-0 through 42-7), belonging to the 2 I/O controllers #A and #B (41A and 41B) within each of the I/O boards #0 through #N (4-0 through 4-N), to the PCI function numbers F#0 through F#7, according to an embodiment of the present invention. As shown in FIG. 9, the assignments to the function numbers F#0 through F#7 can be made so that the I/O ports 42-0 through 42-7 belong to the I/O controller 41A, and the assignments to the function numbers F#0 through F#7 can be made so that the I/O ports 42-0 through 42-7 belong to the I/O controller 41B.

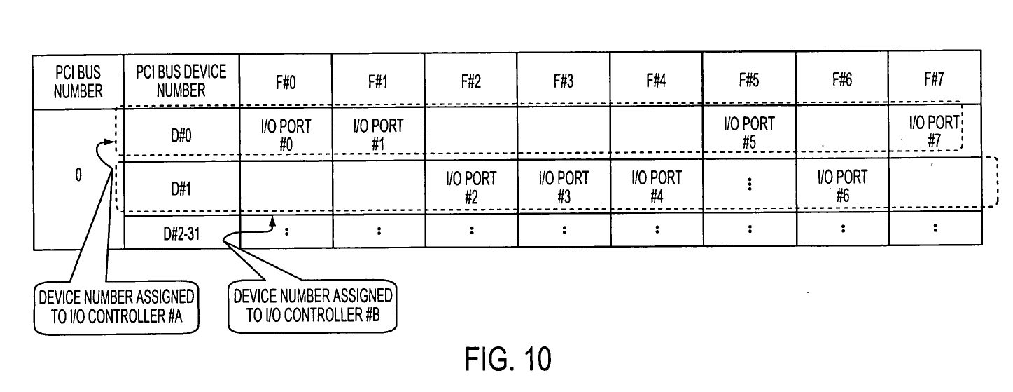

As another example, FIG. 10 is a diagram showing the assignments of the PCI function numbers F#0 through F#7 to different I/O ports 42 of I/O controllers 41A, 41B for a case where the I/O ports #0, #1, #5 and #7 (42-0, 42-1, 42-5 and 42-7) of the I/O board #0 (4-0) belong to the I/O controller #A (41A), and the I/O ports #2, #3, #4 and #6 (42-2, 42-3, 42-4 and 42-6) of the same I/O board #0 (4-0) belong to the I/O controller #B (41B), according to an embodiment of the present invention. In FIG. 10, it is assumed for the sake of convenience that the I/O controllers 41A and 41B of the I/O board 4-0 belong to the same partition. In a case where the I/O controllers 41A and 41B of the I/O board 4-0 belong to mutually different partitions, two information groups as surrounded by dotted lines in FIG. 10 would be assigned to the function numbers F#0 through F#7 in the corresponding PCI configuration spaces, that is, the corresponding partitions of processor board(s) 2-0 and I/O controller 41A or 41B within an I/O board 4-0. Accordingly, an embodiment of the present invention can support a multifunction PCI device with each PCI function assigned to any I/O ports 42 of I/O controllers 41 in an I/O board 4. As illustrated in FIGS. 8-10 examples, in case of eight (8) supported PCI functions for a PCI device and eight (8) supported I/O ports 42-0-7, a PCI function to I/O port assignment data structure can be generated (e.g., real-time and/or dynamic) in which three information of PCI bus no., PCI bus device no. and PCI function no. can identify any one of the 8 I/O ports 42-0-7 of I/O controllers 41-A, B, within an I/O board 4-0 to which a PCI function no. belongs.

Accordingly, in the I/O port assignment information register 433 of the register part 43 within each I/O port 42, it is sufficient to set an identifier (ID) of a partition assign unit within the I/O board (LSI) 4-0 in which each I/O port 42 exists, that is, to set I/O port assignment information that indicates an I/O controller 41A or 41B to which each I/O port 42 belongs. In other words, it is unnecessary to set the address (PCI bus number, device number and function number) of the I/O port in the PCI bus configuration space in the I/O port assignment information register 433 of the register part 43 within each I/O board 4-0 for each I/O port 42.

Therefore, according to the present invention, it is possible to arbitrarily set I/O port assignment information that indicates I/O controllers 41 (e.g., 41A or 41B) to which I/O ports 42 (e.g., 42-0 through 42-7) belong, in each of the I/O boards 4-0 through 4-N. Since a partition can be determined in units of the processor boards 2-0 and I/O controllers 41 within an I/O board 4-0, it is possible to flexibly assign the I/O ports 42-0 through 42-7 of each of the I/O boards 4-0 through 4-N with respect to the I/O controllers 41 (e.g., 41A and 41B) to suit needs. As a result, in unlimiting examples, the degree of freedom of partition allocation is improved, and/or the utilization efficiency of the resources is also improved. Moreover, the I/O port assignment information may be set by software, and not by a switching by hardware. For example, the present invention is suited for application to computer systems that allocate I/O controllers and I/O ports to a plurality of partitions.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A partition allocation method for a computer system in which a plurality of processor boards and a plurality of input and output (I/O) boards are coupled via an address and data crossbar, to allocate partitions in units of the processor boards and in units of I/O controllers within the I/O boards, the method comprising:
setting information that indicates partitions to which a plurality of I/O ports within each of the I/O boards belong, by software, in an I/O port assignment register part within a corresponding one of the I/O boards.

2. The partition allocation method as claimed in claim 1, wherein the setting of the I/O port partition information by software comprises setting an identifier (ID) of a partition assignment within each I/O board in which each of the I/O ports exists.

3. The partition allocation method as claimed in claim 1, wherein the setting of the I/O port partition information by software comprises setting assignment information indicating the I/O controllers within each I/O board in which each of the I/O ports exists.

4. The partition allocating method as claimed in any of claims 1 to 3, further comprising executing the by software setting via an arbitrary one of a plurality of processors within an arbitrary one of the processor boards.

5. A computer system, comprising:
a plurality of processor boards each including a plurality of processors;
a plurality of input and output (I/O) boards each including a plurality of I/O controllers and a plurality of I/O ports; and
an address and data crossbar coupling the plurality of processor boards and the plurality of I/O boards,
wherein each of the I/O boards includes a register part software settable with information indicating partitions to which the plurality of I/O ports within said each of the I/O boards belong.

6. The computer system as claimed in claim 5, wherein assignment information indicating the I/O controllers within the I/O board to which each of the I/O ports is assigned is set in the register part as said information indicating partitions to which the plurality of I/O ports within said each of the I/O boards belong.

7. The computer system as claimed in claim 5 or 6, wherein an arbitrary one of a plurality of processors within an arbitrary one of the processor boards executes the software.

8. The computer system according to claim 6, wherein said register part includes a device number register to store a device number of each of the I/O controllers within said corresponding one of the I/O boards, an address range register to store an address range of each of the I/O ports within said corresponding one of the I/O boards, and an assignment information register in which said information is set indicating the assigned I/O controllers of the I/O ports within said corresponding one of the I/O boards.

9. The computer system as claimed in claim 8,
wherein the computer system configures a partition ID written with a device number of an I/O controller to which an I/O port belongs at a time of booting the computer system and/or according to dynamic reconfiguration methods of the computer system, and
wherein said corresponding one of the I/O boards, upon receipt of a request packet instructing an access from an arbitrary one of the processor boards towards a desired I/O device that is coupled to said corresponding one of the I/O boards, compares the partition ID of the request packet with device numbers of the I/O controllers that are stored in the device number register, based on the assignment information that is set in the assignment information register, and at same time, compares an address of the request packet with address ranges of each of the I/O ports that are stored in the address range register, so that the request packet reaches only an I/O port that belongs to the I/O controller having the matching device number and the matching address as a result of the comparisons made.

10. The computer system as claimed in claim 8, wherein said corresponding one of the I/O boards, upon receipt via one I/O port of a request instructing an access from an I/O device that is coupled to said corresponding one of the I/O boards towards a desired processor board, sends to the desired processor board via the address and data crossbar a request packet having a partition identifier (ID) written with a device number of the I/O controller to which said one I/O port belongs.

11. The method of claim 4, wherein the arbitrary one of the processor boards is a configuration management processor board.

12. The computer system of claim 7, wherein the arbitrary one of the processor boards executing the software setting is a configuration management processor board.

13. The method of claim 1, further comprising:
storing a device number of each of the I/O controllers within said corresponding one of the I/O boards, and storing an address range of each of the I/O ports within said corresponding one of the I/O boards;
configuring a data packet partition identifier (ID) comprising a device number of an I/O controller to which an I/O port belongs to enable, upon receipt of a data packet, comparing of the partition ID of the data packet with the stored device numbers of the I/O controllers, based on the by software set I/O port assignment information, and comparing of an address of the data packet with the stored address ranges of each of the I/O ports, wherein the data packet reaches only a partition having the matching device number and the matching address according to the partition ID comparing and the address comparing.

14. The method of claim 13, wherein the configuring of the data packet partition ID is performed at a time of booting the computer system and/or according to dynamic reconfiguration methods of the computer system.

15. An apparatus, comprising:
a plurality of input and output (I/O) controllers and a plurality of I/O ports in communication with the I/O controllers; and
a partition allocator software settable with I/O port partition assignment information indicating a partition, in a unit of one I/O controller and one I/O port, to which an I/O port is assigned.

16. The apparatus of claim 15, wherein each I/O controller is assigned a device number, and the partition allocator comprises:
an I/O port assignment register storing the I/O port partition assignment information;
a first circuit, upon receipt of a data packet, comparing a partition ID of the data packet with device numbers of the I/O controllers stored in a device number register, based on the I/O port partition assignment information set in the I/O port assignment information register; and
a second circuit comparing an address of the data packet with address ranges of each of the I/O ports stored in an address range register,
wherein the data packet reaches only a partition having the matching device number and the matching address according to the partition ID comparing and the address comparing.

17. The apparatus of claim 15, wherein the I/O controllers and the I/O ports are according to Peripheral Component Interconnect (PCI) to communicably interface with a PCI device.

18. An apparatus, comprising:
a plurality of processor boards;
a plurality of input and output (I/O) boards in communication with the plurality of processor boards, each I/O board comprising:
a plurality of input and output (I/O) controllers and a plurality of I/O ports in communication with the I/O controllers; and
a partition allocator software settable with I/O port partition assignment information indicating a partition, in a unit of a processor board and one I/O controller and one I/O port within an I/O board, to which an I/O port is assigned.

19. The apparatus of claim 18,
wherein the I/O controllers and the I/O ports within the I/O board are according to Peripheral Component Interconnect (PCI) to communicably interface with a multifunction PCI device comprising a plurality of PCI functions, and
wherein a processor board generates a PCI function to I/O port assignment data structure that identifies any one of the I/O ports of the I/O controllers within an I/O board to which a PCI function of a PCI device belongs.

20. A partition allocation method for a computer system in which a plurality of processor boards and a plurality of input and output (I/O) boards are coupled via an address and data crossbar, to allocate partitions in units of the processor boards and in units of I/O controllers within the I/O boards, the method comprising:
enabling setting of information that indicates partitions to which a plurality of I/O ports within each of the I/O boards belong, by software, in an I/O port assignment register part within a corresponding one of the I/O boards;
enabling upon receipt of a data packet, comparing of a partition ID of the data packet with stored device numbers of the I/O controllers, based on the by software set I/O port assignment information, and allowing comparing of an address of the data packet with stored address ranges of each of the I/O ports, wherein the data packet reaches only a partition having the matching device number and the matching address according to the partition ID comparing and the address comparing.

21. An apparatus, comprising:
a plurality of processing means;
a plurality of input and output (I/O) means in communication with the plurality of processing means, each I/O means comprising:
a plurality of input and output (I/O) controlling means and a plurality of I/O port means in communication with the I/O controlling means; and
partition allocation means for setting I/O port partition assignment information indicating a partition, in a unit of a processing means and one I/O controller and one I/O port within an I/O board, to which an I/O port is assigned.
